(19) United States
(12) Patent Application Publication
(10) Pub. No.: US 2007/0009316 A1
(43) Pub. Date: Jan. 11, 2007

(54) Combination multi-function tool and writing instrument

(76) Inventor: Judith A. Shelton, Houston, TX (US)

Correspondence Address: ROBERT THOMPSON, 6114 RAINTREE DRIVE, ORLANDO, FL, 32822, US

(21) Appl. No.: 11/096,951

(22) Filed: Jul. 11, 2005

(51) Int. Cl. B43K 29/00

(52) U.S. Cl. 401/195

(57) ABSTRACT

A multi-function tool comprising a writing means having an elongated body and a means for handling pills.

### BACKGROUND

The following is offered as background information only and is not admitted to be prior art to the present invention.

In embodiments, the present invention generally relates to a mufti-function tool for use by pharmacists and technicians in computing medical prescriptions and more particularly, the instant invention relates to a new and novel pill and capsule counting multifunctional tool combined with a means for writing and recording the number of pills.

During the day, a pharmacist is required to handle and count the number of pills, tablets, capsules and the like, for numerous customers. Typically, handling is done through the use of a scoop or through the use of various types of spatulas. It is also necessary for the pharmacist or technician to write and record the number of pills and the like that have been counted. Often, pharmacists and technicians have suffered the inconvenience of working without such tools from time to time through failure to maintain an adequate inventory of these items, or through an inability to readily locate each item when required.

The present invention combines the functions of a writing instrument with that of a scoop or spatula.

In embodiments the present invention relates to a multi-function tool for scoping and/or counting pills and the like, and more particularly the tool doubles as a writing instrument. The term “pills” as used herein refers to tablets, gelcaps, capsules, and the like.

### SUMMARY

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

The present invention provides a multifunction tool which is a combination of a writing instrument with a scoop or spatula for handling and counting pills.

One feature of the present invention in embodiments it to provide, for example, a multi-function tool which combines, for example, the functions of a pencil, pen, marker, highlighter, and the like.

Another feature of the present invention is to provide, for example, the pharmacist or technician a multi-function tool having a low cost of manufacture with regard to both materials and labor, and which accordingly may be offered for sale at a low price to the consumer. Additionally, the multi-function tool will be quite simple in construction, easy to use, and extremely efficient.

Present day pharmacists and technicians generally use pill counting devices which allows them, when filling a prescription for a specified number of pills, to pour uncounted pills from a bulk container onto a tray having a collecting bin positioned along one side margin thereof and a spout on the opposite side thereof. The term “pills” as used herein refers to tablets, gelcaps, capsules, and the like. The specified number of pills is pushed into the bin, typically by a spatula or scoop. The bin is closed and the overage pills remaining on the tray are returned to the bulk container via a spout. The specified number of pills is typically poured from the bin via an opening at one end of the bin to an appropriate container via an opening in the bin.

In embodiments the present invention comprises a multi-function tool which can be utilized as a writing instrument, and as a means for handling pills in a pharmaceutical or laboratory setting. The tool is generally comprised of a writing instrument having an elongated body, a handling means, for example, a spatula or scoop for handling and counting pills, tablets, capsules, and the like.

The writing instrument is formed integrally with the elongated body of the multi-function tool or formed into the body of the multi-function tool for ease of retraction.

In one embodiment, the present invention provides, for example, a method for counting and recording the number of pills, capsules, tablets and the like by a pharmacist or technician.

In another embodiment of the present invention, the writing instrument is selected from the group consisting of pencils, pens, highlighters, markers, laser pointers, computer mice, and the like.

In a further embodiment of the present invention, there is provided a tool for use in a pharmacy, laboratory, hospital, and the like. More specifically, the invention, in embodiments relates to the use by the pharmacists and technicians in the quick, efficient and accurate count and recording of pills, tablets, capsules and the like, without interruption. Embodiments of the invention also provide a tool to eliminate unnecessary counter clutter which may distract the pharmacists and technicians.

In yet another embodiment of the present invention there is provided a tool for use by the pharmacist and technician can easily, smoothly, and without difficulty be inverted within seconds from a counting tool to a writing implement.

### BRIEF DESCRIPTION OF THE DRAWINGS

In a further effort to make the above-recited features and aspects of the specific embodiments of the invention, clear, more specific descriptions of the invention briefly summarized above may be had by reference to embodiments thereof which are illustrated in the drawings. These drawings form a part of the specification. It is to be noted, however, that the drawings illustrate embodiments of the invention and therefore are not to be considered limiting in their scope.

FIG. 1 is a cross-sectional view of a first embodiment of the tool of the invention.

FIG. 2 is a cross-sectional view of a second embodiment of the tool of the invention and shows the writing means as retractable and mounted into a bore.

FIG. 3 is a cross-sectional view of a third embodiment of the tool of the invention and shows the writing means as a digital pen.

### DESCRIPTION

Embodiments of the present invention include a multi-function tool which includes a writing instrument.

In one embodiment, the multifunction tool comprises a spatula in combination with a writing instrument.

In another embodiment, the multifunction tool comprises a scoop in combination with a writing instrument.

The multi-function tool may comprise any suitable writing means, including a pencil lead, ball point with associated ink reservoir, crayon, felt-tip highlighter, digital pen, and the like. If desired, the writing means may be retractable. Also, if desired, a major part of the tool may be made from a material which is capable of marking paper and like. Additionally, the writing portion of the tool may be removable and capable of interfacing with a computer for downloading information and/or data. Information such as the number of pills dispensed and counted may be useful for inventory and the like.

In one embodiment, the writing point is coaxial with the shaft of the multi-function tool and is contained within or forms a part of the shaft of the tool.

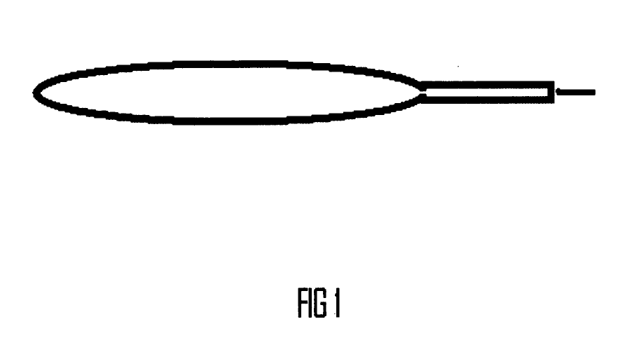

Referring to FIG. 1, the multi-function tool 10 is comprises a tool end 20 and a writing means 30. The tool end 20 consists of a thin blade type structure or a thin scoop type structure. The writing means 30 tapers toward its free end.

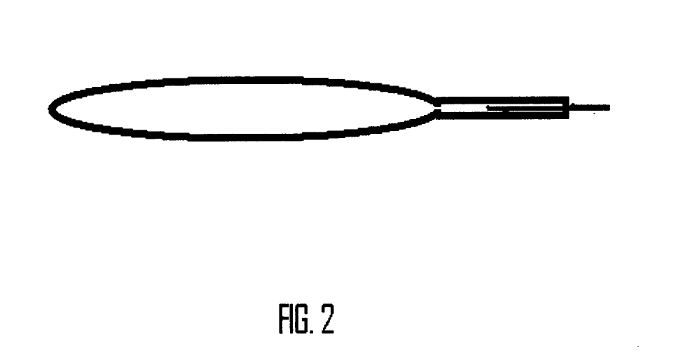

Referring to FIG. 2, which shows another embodiment of the multifunction tool, the writing means is retractable and mounted into bore 31 and held therein by friction, adhesive or any other suitable means.

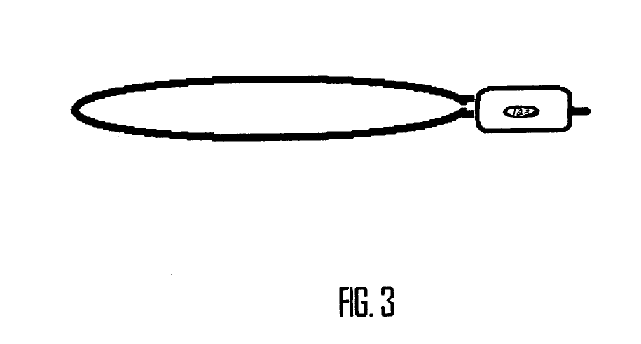

Referring to FIG. 3, a further embodiment of the multifunction tool shows the writing means comprising a digital pen. The digital pen is removable and capable of interfacing with a computer for downloading information stored in the digital pen portion of the multi-function tool.

In a variation of this embodiment, this multifunction tool is capable, when interfacing with a computer, of storing information relating to drug inventory counts, including but not limited to legend drugs and controlled substances. More specifically, the tool allows the pharmacist and technicians to retrieve summarized counts regarding specific legend drugs and/or controlled substances.

The spatula or scoop portion of the multifunction tool may be constructed of one piece of material, for example, steel, plastic, a composite material, and the like.

While the invention has been described, disclosed, illustrated and shown in terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A multi-function tool comprising:
a writing means having an elongated body; and
means for handling pills.

2. The tool of claim 1, wherein said means for handling pills comprises a scoop or a spatula.

3. The tool of claim 1, wherein said means for handling pills consists of a scoop.

4. The tool of claim 1, wherein said means for handling pills consists of a spatula.

5. The tool of claim 1, wherein the writing means is selected from the group consisting of a pencil, pen, marker, highlighter, or a digital pen.

6. The tool of claim 1, wherein the writing means is a pencil.

7. The tool of claim 1, wherein the writing means is a pen.

8. The tool of claim 1, wherein the writing means is a marker.

9. The tool of claim 1, wherein the writing means is a highlighter.

10. The tool of claim 1, wherein the writing means is a digital pen.

11. The tool of claim 1, wherein the writing means and the means for handling pills is integrally formed with the elongated body of the multi-function tool.

12. A multi-function tool, comprising:
a writing means having an elongated body; and
a spatula for handling pills.

13. A multi-function tool according to claim 12, wherein said writing means comprises a pen.

14. A multi-function tool according to claim 12, wherein said writing means comprises a digital pen.

15. The tool of claim 4 wherein said spatula comprises 2 flat sides.

16. The tool of claim 4 wherein said spatula has a length of from about 1 inch to about 10 inches.

17. The tool of claim 3 wherein said scoop has a length of from about 1 inch to about 10 inches.

18. The tool of claim 3 wherein said scoop is made of a material selected from the group consisting of steels, plastics, rubbers, composites, and woods.

19. The tool of claim 4, wherein said spatula is made from a material selected from the group consisting of steels, plastics, rubbers, composites, and woods.

20. A multi-function tool, comprising:
a writing means; and
a scoop for handling pills.

21. A multi-function tool according to claim 20, wherein said writing means comprises a pen.

22. A multi-function tool according to claim 20, wherein said writing means comprises a digital pen.
